(19) United States
(12) Patent Application Publication
(10) Pub. No.: US 2010/0153644 A1
(43) Pub. Date: Jun. 17, 2010

(54) ON DEMAND JAVA APPLICATION MANAGER

(76) Inventors: Frederic J. Bauchot, Saint-Jeannet (FR); Gerard Marrniqere, Drap (FR); Joaquin Picon, St. Laurent du Var (FR); Vincent Tassy, Cagnes sur Mer (FR)

Correspondence Address: HOFFMAN WARNICK LLC, 75 STATE ST, 14 FL, ALBANY, NY, 12207, US

(21) Appl. No.: 12/350,009

(22) Filed: Jan. 7, 2009

(30) Foreign Application Priority Data
Dec. 11, 2008 (EP) 08305917.0

(51) Int. Cl. G06F 12/02; G06F 12/00; G06F 13/28; G06F 13/00

(52) U.S. Cl. 711/118; 711/E12.009

(57) ABSTRACT

A system, method and program product for providing an on demand Java application manager. A system is provided that includes: a bootstrap system for setting up a cache within a local storage and pointing to at least one application at a network resource; a class loader that loads class files for a selected application into the JVM in an on demand fashion, wherein the class loader searches for a requested class file initially in the cache and if not present downloads the requested class file from the network resource to the cache; and a disk management system that manages storage space in the cache, wherein the disk management system includes a facility for discarding class files from the cache.

### FIELD OF THE INVENTION

This disclosure relates to managing applications on a computer system to efficiently utilize storage, and more particularly relates to a Java application manager that downloads applications and classes on demand from a network server to more effectively manage storage requirements.

### BACKGROUND OF THE INVENTION

Over the past 20 years or so, the trend of software development has been towards larger application sizes that require more and more disk space. Personal computing environments have followed by implementing large amounts of storage for installing and maintaining such applications. Unfortunately, the trend toward large applications has several obvious drawbacks. Firstly, computing hardware must constantly be upgraded to handle larger and larger storage requirements. Secondly, the application installation and update process is often a time consuming process that requires large numbers of files to be copied to the computer's hard drive.

One reason for size inflation is the fact that software applications are often bundled with numerous features and functions that bloat the size. During development, software developers will often save development time by re-using existing code segments that include numerous useless functions. Moreover, it is not unusual for each new version of an application to add new and more robust features, which only increase the size of the application. Often, a software application will include numerous features that are either rarely or never used by the end user. For instance, Microsoft WORD comes with dozens of features that can be accessed using dropdown menus. In many cases, the user will only utilize a small subset of all of the available features over the lifetime of the program. Despite this, the code still sits on the hard disk and very often is loaded in memory.

Given the trend towards different sized device platforms, e.g., handheld devices, smart appliances, thin computing, etc., providing large amounts of storage space to handle these bloated applications is simply not practical or cost effective. Nonetheless, demand continues to exist for robust applications that can be developed quickly and provide large feature sets. Accordingly, a need exists for allowing such robust applications to be made available to computing devices having limited storage.

### SUMMARY OF THE INVENTION

The present invention relates to a system, method and program product for providing on demand application loading and management in a Java environment. In one embodiment, there is a system for managing Java applications for execution on a Java Virtual Machine (JVM) running on a computer system, comprising: a bootstrap system for setting up a cache within a local storage and pointing to at least one application at a network resource; a class loader that loads class files for a selected application into the JVM in an on demand fashion, wherein the class loader searches for a requested class file initially in the cache and if not present downloads the requested class file from the network resource to the cache; and a disk management system that manages storage space in the cache, wherein the disk management system includes a facility for discarding class files from the cache.

In a second embodiment, there is a computer readable medium having a program product stored thereon for managing Java applications for execution on a Java Virtual Machine (JVM), comprising: program code for setting up a cache within a local storage and pointing to at least one application at a network resource; program code that loads class files for a selected application into the JVM in an on demand fashion, wherein the loading searches for a requested class file initially in the cache and if not present downloads the requested class file from the network resource to the cache; and program code that manages storage space in the cache, which includes a facility for discarding class files from the cache.

In a third embodiment, there is a method for managing Java applications for execution on a Java Virtual Machine (JVM), comprising: setting up a cache within a local storage; providing access to at least one application at a network resource; loading class files for a selected application into the JVM in an on demand fashion, wherein the loading searches for a requested class file initially in the cache and if not present downloads the requested class file from the network resource to the cache; and discarding class files from the cache.

In a fourth embodiment, there is a method for deploying a system for managing Java applications for execution on a Java Virtual Machine (JVM), comprising: providing a computer infrastructure being operable to: set up a cache within a local storage; provide access to at least one application at a network resource; load class files for a selected application into the JVM in an on demand fashion, wherein the loading searches for a requested class file initially in the cache and if not present downloads the requested class file from the network resource to the cache; and discard class files from the cache.

The illustrative aspects of the present invention are designed to solve the problems herein described and other problems not discussed.

### BRIEF DESCRIPTION OF THE DRAWINGS

These and other features of this invention will be more readily understood from the following detailed description of the various aspects of the invention taken in conjunction with the accompanying drawings.

FIG. 1 depicts a computer system having an on demand application manager in accordance with an embodiment of the present invention.

FIGS. 2-3 and depict an illustrative application suitable for implementation in accordance with an embodiment of the present invention.

FIG. 4 depicts a flow diagram of a method in accordance with an embodiment of the present invention.

The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

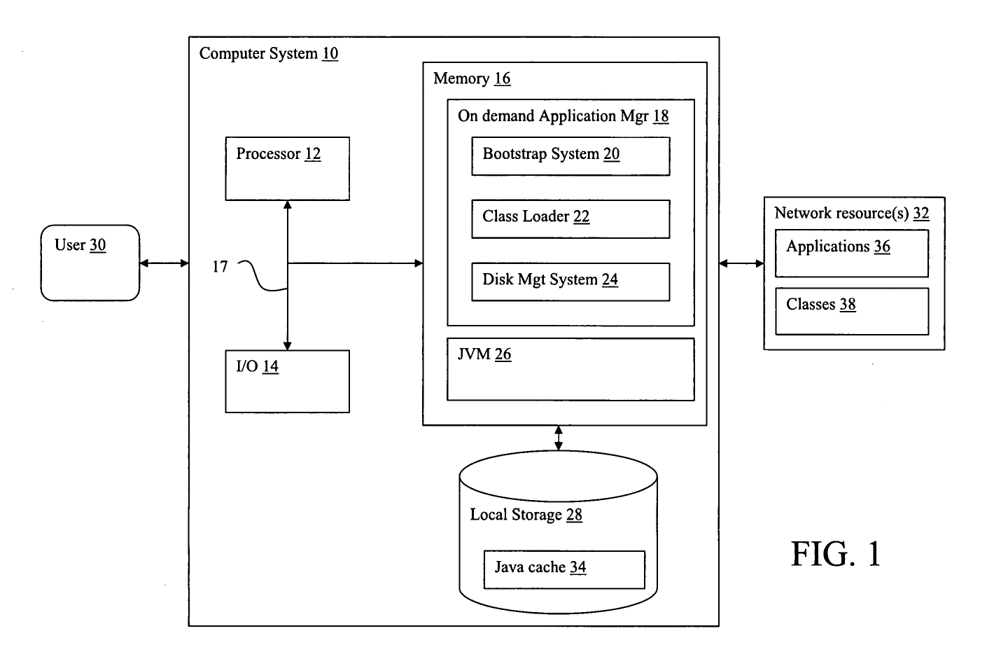

Referring to the drawings, FIG. 1 depicts a computer system 10 having an on demand application manager 18 for allowing applications and associated classes to be loaded onto the Java Virtual Machine (JVM) 26 from a dedicated Java cache 34 within local storage 28 of computer system 10. Application code however is not stored in the Java cache 34 unless the application is actually run by the computer system 10. Likewise, associated classes are only stored in the Java cache 34 if the class is needed to implement a required function or feature of the application. If the required application code or class is not in the java cache 34, an application 36 or class 38 is downloaded from a network resource 32 to the Java cache 34 for processing by the JVM 26, in an on demand fashion. The class 38 or application 36 remains in the Java cache 38 for a period of time as dictated by time and/or space constraints set forth by disk management system 24. Thus, commonly used applications or classes may remain in the Java cache 34 indefinitely, while infrequently used applications and classes may be removed after a period of non-use. Classes that are not required by the application during operation of the application by the user 30 are not loaded into the Java cache 34.

For example, a word processing program being run by an end user 30 may provide the feature of allowing a table to be built and inserted into a document. If the user 30 never utilizes this capability, the classes for implementing this feature would not be loaded to the Java cache 34. If at some time user 30 decided to utilize the table feature, the associated class or classes 38 would be downloaded from a network resource 32.

To implement this process, on demand application manager 18 generally includes: a bootstrap system 20 that provides a bootstrap code segment for initially setting up and launching the on demand application manager 18; a class loader 22 for loading classes from either local storage 28 (if available) or one or more network resources 32; and a disk management system 24 for managing the storage space associated with Java cache 34.

Bootstrap system 20 may for instance comprise one or more files that can be downloaded from a network resource using, e.g., a web browser. Once the bootstrap system 20 is installed, it can be utilized to initially set up and configure the on demand application manager 18. Bootstrap system 20 may include: ajar file with the bootstrap class (i.e., application) and a manifest file containing a server URL where applications 36 are available. The user 30 can configure the java cache 34, e.g., setting a maximum size to be used, etc. Execution of the bootstrap class reads the manifest file and prompts the user 30 for a location on the local storage 28 of the Java cache 34. Once configured, the settings of the java cache 34 are made available to the class loader 22.

Once launched, the bootstrap application points to one or more network resources 32 (e.g., servers). On a given server, a list of applications 36 may be provided to the user 30. By selecting one of the applications 36, the minimum code to start the application 36 is downloaded to the Java cache.

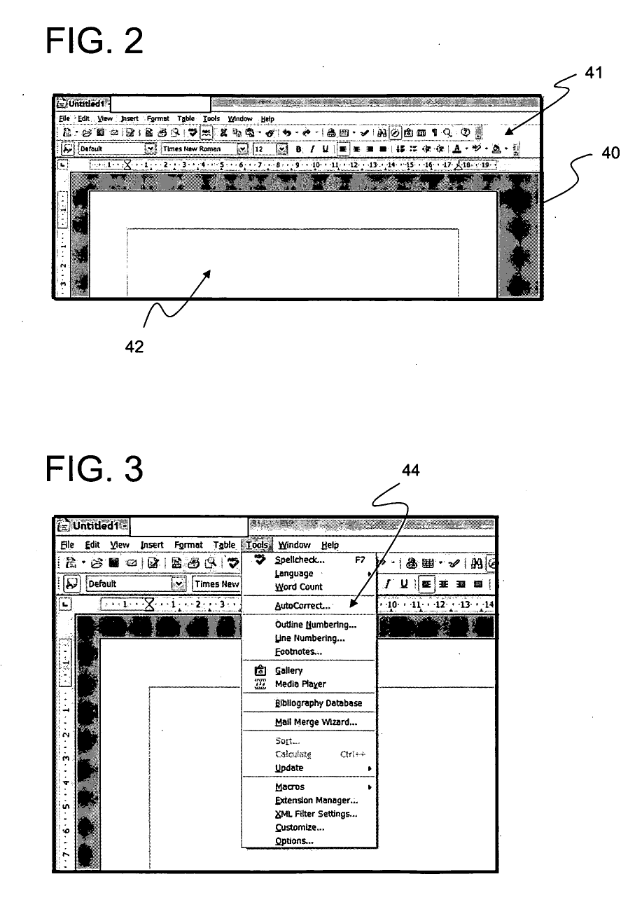

For example, FIG. 2 depicts the word processing application “OpenOffice” in a window 40. Assuming this is the first time the application is run by user 30, the minimum code necessary to display the interface 41 as shown is loaded from a network resource 32 to the Java cache 34 and then to JVM 26. In this example, the minimum code may for instance allow the user 30 to enter text onto the document area 42 and view the tool bars and features as if the complete version was loaded.

As shown in FIG. 3, the user 30 is able to select dropdown menu 44 and view all of the features available in the application. In accordance with an embodiment of the invention, however, the corresponding code to support these features is not loaded to the Java cache 34 or JVM 26 unless the user 30 selects (i.e., clicks on) the feature. If the user 30 does indeed select a feature, the class loader 22 (FIG. 1) looks to the Java cache 34 to see if the class (i.e., class file) for the feature has already been downloaded to the Java cache 34. If the class is not found, the class loader 22 uses, e.g., a configured URL to request the class file from the server providing the application. The corresponding class file is then downloaded to the Java cache 34 within the local storage 28. If the requested class file is not available from the server, either an error message can be displayed to the user or the class loader 22 can search for the class file at a different network resource 32.

Disk management system 24 manages the Java cache 34 to ensure efficient use of the limited storage resources. In particular, disk management system 24 may utilize any algorithm or process to discard files from the Java cache to ensure that enough space exists to hold current classes. For instance, disk management system 24 may be implemented with an aging algorithm to automatically remove files from the Java cache 34 that have not been utilized in a predetermined time. Moreover, disk management system 24 may include a dynamic process that checks the amount of available space whenever the class loader 22 seeks to download a new file into the Java cache 34. If not enough room exists, disk management system 24 can identify the least recently used class files and discard them. Once a minimum amount of disk space becomes available, the requested class can be downloaded from the network resource 32.

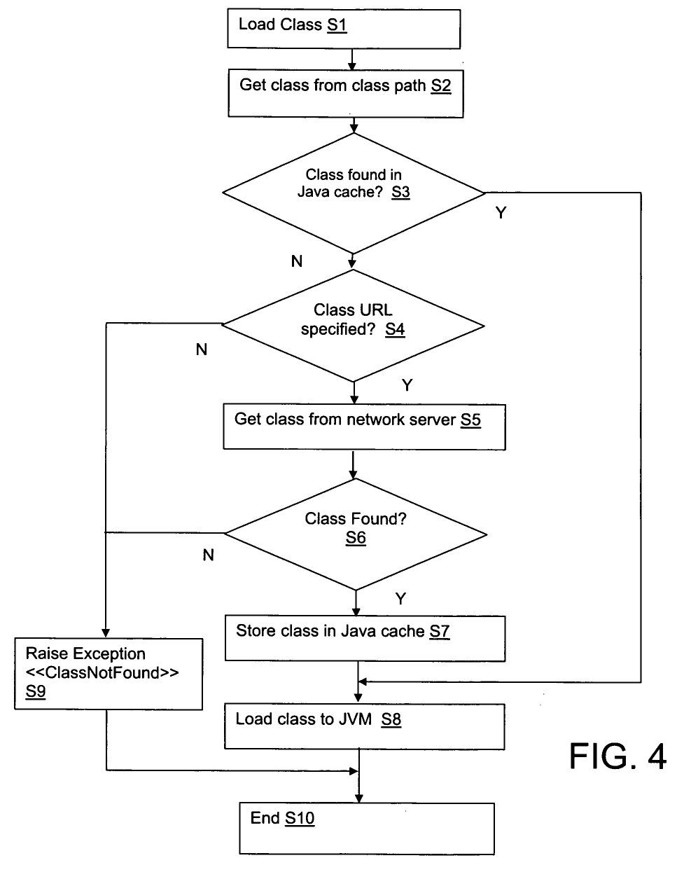

Referring now to FIG. 4, a flow diagram for showing a process for implementing a method of the invention is provided. At S1, a load class command is executed by the JVM, and the class path is utilized to get the class at S2. At S3, a check is made to see if the class is in the Java cache. If it is, the class is loaded to the JVM at step S8. If not, a check is made to see if a class URL is specified at S4. If not, an exception is raised at S9, e.g., <<ClassNotFound>>. If a URL is specified, an attempt is made to get the class from the specified network server at S5. At S6, a check is made is to see if the class was found at the network server. If no, an exception is raised at S9. If yes, the class is downloaded and stored in the Java cache at S7, and is then loaded into the JVM at S8. The process then ends at S10.

A feature of the described embodiments is that the Java cache 34 can be copied or moved from one computer system to another easily, and thus allows for simple portability of applications. For instance, the Java cache 34 may be set up in a flash drive that can be removed from the USB of a first computing device and plugged into a USB of a second computing device.

Referring again to FIG. 1, it is understood that computer system 10 may be implemented as any type of computing infrastructure. Computer system 10 generally includes a processor 12, input/output (I/O) 14, memory 16, and bus 17. The processor 12 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, memory 16 may reside at a single physical location, comprising one or more types of data storage, or be distributed across a plurality of physical systems in various forms.

I/O 14 may comprise any system for exchanging information to/from an external resource. External devices/resources may comprise any known type of external device, including a monitor/display, speakers, storage, another computer system, a hand-held device, keyboard, mouse, voice recognition system, speech output system, printer, facsimile, pager, etc. Bus 17 provides a communication link between each of the components in the computer system 10 and likewise may comprise any known type of transmission link, including electrical, optical, wireless, etc. Although not shown, additional components, such as cache memory, communication systems, system software, etc., may be incorporated into computer system 10. Local storage 28 may comprise any type of read write memory, such as a disk drive, optical storage, USB key, memory card, flash drive, etc.

Access to computer system 10 and network resources 32 may be provided over a network such as the Internet, a local area network (LAN), a wide area network (WAN), a virtual private network (VPN), wireless, cellular, etc. Communication could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity. Further, as indicated above, communication could occur in a client-server or server-server environment.

It should be appreciated that the teachings of the present invention could be offered as a business method on a subscription or fee basis. For example, a computer system 10 comprising an on demand application manager 18 could be created, maintained and/or deployed by a service provider that offers the functions described herein for customers. That is, a service provider could offer to deploy or provide application management as described above.

It is understood that in addition to being implemented as a system and method, the features may be provided as a program product stored on a computer-readable medium, which when executed, enables computer system 10 to provide an on demand application manager 18. To this extent, the computer-readable medium may include program code, which implements the processes and systems described herein. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 16 and/or a storage system, and/or as a data signal traveling over a network (e.g., during a wired/wireless electronic distribution of the program product).

As used herein, it is understood that the terms “program code” and “computer program code” are synonymous and mean any expression, in any language, code or notation, of a set of instructions that cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like. Further, it is understood that terms such as “component” and “system” are synonymous as used herein and represent any combination of hardware and/or software capable of performing some function(s).

The block diagrams in the figures illustrate the architecture, functionality, and operation of possible implementations of systems, methods and computer program products according to various embodiments of the present invention. In this regard, each block in the block diagrams may represent a module, segment, or portion of code, which comprises one or more executable instructions for implementing the specified logical function(s). It should also be noted that the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams can be implemented by special purpose hardware-based systems which perform the specified functions or acts, or combinations of special purpose hardware and computer instructions.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A system for managing Java applications for execution on a Java Virtual Machine (JVM) running on a computer system, comprising:
a bootstrap system for setting up a cache within a local storage and pointing to at least one application at a network resource;
a class loader that loads class files for a selected application into the JVM in an on demand fashion, wherein the class loader searches for a requested class file initially in the cache and if not present downloads the requested class file from the network resource to the cache; and
a disk management system that manages storage space in the cache, wherein the disk management system includes a facility for discarding class files from the cache.

2. The system of claim 1, wherein the bootstrap system includes a facility for setting a size of the cache.

3. The system of claim 1, wherein the disk management system discards a class file after a predetermined amount of time passes without the file being used.

4. The system of claim 1, wherein the disk management system discards at least one previously used class file if the cache does not have enough space to load a currently requested file.

5. The system of claim 1, wherein the selected application is initially run on the JVM with a minimum configuration, and an activation of a feature within the selected application by a user causes the class loader to search for a class file to implement the feature.

6. The system of claim 1, further comprising a system for raising a ClassNotFound exception if the requested class file is not located at either the cache or the network resource.

7. The system of claim 1, wherein the network resource is identified using a URL.

8. A computer readable medium having a program product stored thereon for managing Java applications for execution on a Java Virtual Machine (JVM), comprising:
program code for setting up a cache within a local storage and pointing to at least one application at a network resource;
program code that loads class files for a selected application into the JVM in an on demand fashion, wherein the loading searches for a requested class file initially in the cache and if not present downloads the requested class file from the network resource to the cache; and
program code that manages storage space in the cache, which includes a facility for discarding class files from the cache.

9. The computer readable medium of claim 8, wherein setting up the cache includes setting a size of the cache.

10. The computer readable medium of claim 8, wherein the program code that manages storage space discards a class file after a predetermined amount of time passes without the file being used.

11. The computer readable medium of claim 8, wherein the program code that manages storage space discards at least one previously used class file if the cache does not have enough space to load a currently requested file.

12. The computer readable medium of claim 8, wherein the selected application is initially run by the JVM with a minimum configuration, and an activation of a feature within the selected application by a user causes a search for a class file to implement the feature.

13. The computer readable medium of claim 8, further comprising a program code for raising a ClassNotFound exception if the requested class file is not located at either the cache or the network resource.

14. The computer readable medium of claim 8, wherein the network resource is identified using a URL.

15. A method for managing Java applications for execution on a Java Virtual Machine (JVM), comprising:
setting up a cache within a local storage;
providing access to at least one application at a network resource;
loading class files for a selected application into the JVM in an on demand fashion, wherein the loading searches for a requested class file initially in the cache and if not present downloads the requested class file from the network resource to the cache; and
discarding class files from the cache.

16. The method of claim 15, wherein setting up the cache includes setting a size of the cache.

17. The method of claim 15, wherein class files are discarded after a predetermined amount of time passes without the file being used.

18. The method of claim 15, wherein class files are discarded if the cache does not have enough space to load a currently requested file.

19. The method of claim 15, wherein the selected application is initially run by the JVM with a minimum configuration, and an activation of a feature within the selected application by a user causes a search for a class file to implement the feature.

20. A method for deploying a system for managing Java applications for execution on a Java Virtual Machine (JVM), comprising:
providing a computer infrastructure being operable to:
set up a cache within a local storage;
provide access to at least one application at a network resource;
load class files for a selected application into the JVM in an on demand fashion, wherein the loading searches for a requested class file initially in the cache and if not present downloads the requested class file from the network resource to the cache; and
discard class files from the cache.
